(19) United States
(12) Patent Application Publication
(10) Pub. No.: US 2022/0180712 A1
(43) Pub. Date: Jun. 9, 2022

(54) SKIMMER DETECTION WAND

(71) Applicants: University of North Texas, Denton, TX (US); Cyber Defense Labs, LLC, Richardson, TX (US)

(72) Inventors: Scott H. Belshaw, Denton, TX (US); Michael Saylor, Richardson, TX (US)

(21) Appl. No.: 17/593,939

(22) PCT Filed: Apr. 6, 2020
(86) PCT No.: PCT/IB2020/053286

§ 371 Date: Sep. 28, 2021

Related U.S. Application Data
(60) Provisional application No. 62/831,607, filed on Apr. 9, 2019.

(51) Int. Cl. G07F 19/00; G07F 7/08; H04N 5/33

(52) U.S. Cl. CPC G07F 19/2055; H04N 5/33; G07F 7/088

(57) ABSTRACT

Embodiments provide a skimming detection device including a one or more sensors configured to detect characteristics that may be used to detect the presence of a skimming device. Sensor data generated by the sensor(s) may be compared to reference sensor data to detect the presence of a skimming device. An output that indicates whether a skimming device is not present, likely present (e.g., the consumer or user should assume the scanned device contains a skimmer or has otherwise been compromised), or confirmed to be present may be generated and presented to a user. Such capabilities may enable user to quickly scan a device (e.g., an ATM, a fuel pump, etc.) to determine whether a skimming device is present and take action to mitigate the use of any detected skimming devices.

O

### PRIORITY

This application claims the benefit of priority of U.S. Provisional Patent Application No. 62/831,607, filed Apr. 9, 2019, which is hereby incorporated by reference in its entirety.

### TECHNICAL FIELD

The present application relates to technologies for mitigating risk of data theft and more specifically, to devices for detecting skimming devices configured to facilitate theft of financial card data.

### BACKGROUND

Efforts to skim information from financial cards (e.g., credit cards and debit cards) have become widespread. Skimming devices have become very small, allowing them to be placed within or over existing devices that consumers frequently utilize to facilitate financial card purchases. For example, skimming devices are frequently used to conduct skimming attacks on automated teller machines, fuel pumps, and other point of sale (POS) devices. Skimming devices are typically small battery operated devices that utilize card readers and cameras to capture financial card data (e.g., financial card number, expiration date, etc.) and personal identification number (PIN) data entered by consumers. The captured data may be stored locally on the device where it may be retrieved at a later time by the perpetrator, or it may be transmitted wirelessly via Bluetooth or another communication protocol to the perpetrator, such as by retrieving data captured by a skimming device installed at a fuel pump using a laptop computing device.

### SUMMARY

The present application relates to systems, methods, and computer-readable storage media configured to detect the presence of skimming devices. The skimming devices may be embedded within other devices, such as when a skimming device is placed within a fuel pump housing, as well as skimming devices overlaid on other devices, such as when a skimming device is inserted into or over a financial card reader of an ATM. In embodiments, a skimming detection device is configured with a plurality of sensors configured to detect characteristics that may be used to detect the presence of a skimming device. The sensor data generated by the plurality of sensors may be compared to reference sensor data to detect the presence of a skimming device. Devices configured according to embodiments may be configured to generate outputs that indicate whether a skimming device is not present, likely present (e.g., the consumer or user should assume the scanned device contains a skimmer or has otherwise been compromised), or confirmed to be present. Such capabilities may enable user (e.g., a customer, a business operator, law enforcement, etc.) to quickly scan a device (e.g., an ATM, a fuel pump, etc.) to determine whether a skimming device is present and take action to mitigate the use of any detected skimming devices as well as prevent the perpetrator (e.g., the entity that provided the skimming device) from retrieving any financial card data that has already been captured by the skimming device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system for detecting skimming devices in accordance with an embodiment of the present application;

FIG. 2 illustrates aspects of detecting a skimming device using devices configured in accordance with an embodiment of the present application; and

FIG. 3 illustrates a flow diagram of a method of detecting a skimming device in accordance with an embodiment of the present application.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

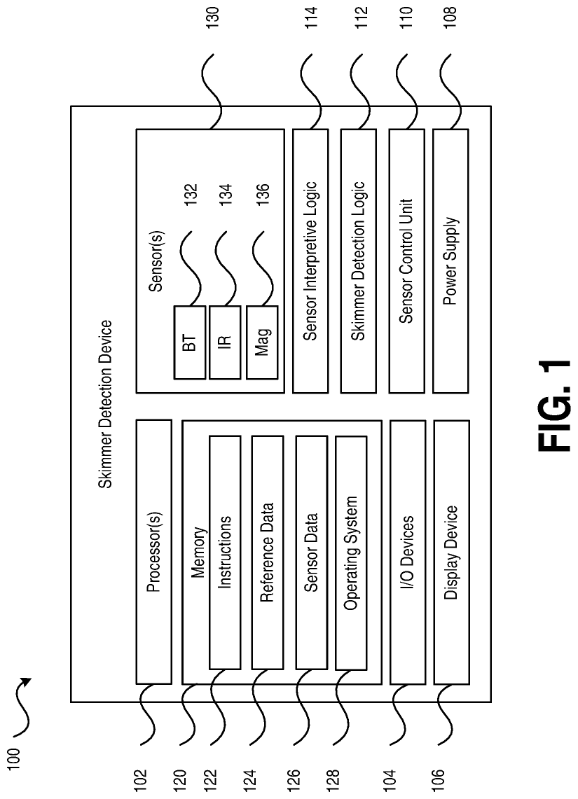

Referring to FIG. 1, a block diagram illustrating a skimmer detection device configured to detect skimming devices in accordance with an embodiment of the present application is shown. As shown in FIG. 1, the skimmer detection device 100 includes one or more processors 102, input/output (I/O) devices 104, a display device 106, a power supply 108, a sensor control unit 110, skimmer detection logic 112, sensor interpretive logic 114, a memory 120, and one or more sensors 130. Each of the one or more processors 102 may be a central processing unit (CPU) having one or more processing cores, or other circuitry configured to execute instructions that facilitate operations of the skimmer detection device 100.

The memory 120 may include read only memory (ROM) devices, random access memory (RAM) devices, one or more hard disk drives (HDDs), flash memory devices, solid state drives (SSDs), other devices configured to store data in a persistent or non-persistent state, or a combination of different memory devices. The memory 120 may store instructions 122 that, when executed by the one or more processors 102, cause the one or more processors 102 to perform the operations described in connection with the skimmer detection device 100 with reference to FIGS. 1-3. Additionally, the memory 120 may also store reference data 124 and an operating system 128. The reference data 124 may correspond to signatures generated based on sensor data detected from known skimming devices by the one or more sensors 130. For example, the reference data 124 may include radio frequency signatures associated with known skimming devices, infrared signatures associated with known skimming devices, or other types of signatures. The reference data 124 may comprise a library of RF signatures associated with RF signatures of skimmer device components (e.g., memory, processors, and the like). The memory 120 may additionally be configured to store sensor data 126 captured by the one or more sensors 130 during operation of the skimmer detection device 100, as described in more detail below.

The one or more sensors 130 may include a Bluetooth sensor 132, an infrared sensor 134, and a magnetometer 136. It is noted that FIG. 1 illustrates the one or more sensors 130 as including three sensors for purposes of illustration, rather than by way of limitation and that embodiments of a skimmer detection device may include more than three sensors or less than three sensors depending on the particular configuration of the skimmer detection device. Additionally, although the sensors are described and illustrated as include Bluetooth sensors, infrared sensors, and magnetometer sensors, embodiments are not limited to these specific sensors and may use other types of sensors that may provide information relevant to detecting the presence of skimming devices. For example, the one or more sensors 130 may additionally include radio frequency (RF) sensors configured to detect RF signals (e.g., non-Bluetooth RF signals) let off by components of a skimming device. It is noted that such RF signals may be associated with various frequencies and may not necessarily be signals utilized for transmission of data (e.g., memory chips, processors, and other electrical components of known skimmer devices emit certain RF signals, which can be detected).

The power supply 108 may be configured to provide operational power to the skimmer detection device 100, such as by supplying power to the skimmer detection device 100 from one or more batteries. The sensor control unit 110 may be configured to provide signals or instructions to the one or more sensors 130 that control the operation of the sensor(s) 130. The skimmer detection logic 112 may be configured to process information or signals detected by the one or more sensors 130 to produce sensor data (e.g., the sensor data 126) and the sensor interpretive logic 114 may be configured to analyze the sensor data 126 and the reference data 124 to determine whether a skimmer device is present within an area under analysis, as described in more detail below. In an aspect, the operations performed by the sensor control unit 110, the skimmer detection logic 112, and the sensor interpretive logic 114 may be stored as part of the instructions 122.

The I/O devices 104 may include various devices configured to receive inputs, such as a mouse, a keyboard, one or more buttons (e.g., a button to initiate sensing operations to detect a skimmer device), one or more switches (e.g., a power switch to turn the skimmer detection device off/on), communication interfaces (e.g., universal serial bus (USB) ports, serial ports, network communication interfaces (e.g., devices that enable the skimmer detection device 100 to communicate over one or more networks), a touchpad, the display device 106, and the like. The I/0 devices 104 may facilitate interaction between a user and the skimmer detection device 100, as described in more detail below.

During operation, a user may interact with one or more of the I/O devices 104 to initiate sensing operations. For example, the user may toggle a power switch to turn the skimmer detection device 100 on. Once powered on, the user may interact with the skimmer detection device to provide an input to initiate operations to detect whether any skimming devices are present in the area proximate to the skimmer detection device, such as to scan one or more fuel pumps at a fueling station or an ATM. In response to the input received, the one or more processors 102 (or the sensor control unit 110) may activate the one or more sensors 130. Once activated, the one or more sensors 130 may begin detecting characteristics of the surrounding environment, such as detecting the presence of one or more Bluetooth enabled device (which may represent potential skimmer devices in the area), detecting heat signatures (e.g., of one or more batteries of a potential skimmer device), and the like. In addition to sensing Bluetooth signals, the one or more sensors 130 may be configured to detect other non-Bluetooth RF signals, which may include RF signals not utilized for transmission of data generated by other electrical components of skimmer devices. Heat signatures may be detected by the IR sensors and may include the IR signature of one or more batteries powering a device, which may aid in detection of skimmer devices embedded within other devices, such as ATMs, fuel pumps, and POSs. As the one or more sensors 130 perform sensing operations, sensor data may be generated and stored as the sensor data 126.

The one or more processors 102 may analyze the sensor data 126 to determine whether one or more skimmer devices are present. The one or more processors 102 may determine whether one or more skimmer devices are present by comparing the sensor data 126 to the reference data 124 to determine whether the sensor data 126 indicates the presence of a skimmer device. For example, if information received from the infrared sensor 134 matches a heat signature of one or more batteries known to be used in skimmer devices, the one or more processors 102 may detect that a possible skimmer device is present. It is noted that the presence of a heat signature corresponding to one or more batteries may indicate the presence of a possible skimmer device because the scanned device, such as an ATM or fuel pump, may not include batteries and the presence of a heat signature associated with batteries in such a device may indicate a foreign device has been embedded within the scanned device. A display device of the skimmer detection device 100 may be configured to display information associated with information feedback of the one or more sensors, such as the IR sensor. For example, the display device may be configured to show an outline of one or more batteries detected within a device by the IR sensor. As another example, certain Bluetooth signals may indicate a possible skimmer device is present (e.g., if a Bluetooth signal is present that is not associated with a device operated by the proprietor of the location where the signal was detected and persists for a period of time). It is noted that the specific examples described above for detecting the presence of a possible skimmer device have been provided for purposes of illustration, rather than by way of limitation and that skimmer detection devices operating in accordance with embodiments of the present disclosure may utilize other types of sensor data and sensor data characteristics to detect the presence of a skimmer device.

After analyzing the sensor data 126 and the reference data 124, the skimmer detection device 100 may generate an output that indicates whether a skimming device is present. The output may be displayed at the display device 106 and may include information that indicates a classification of a skimming device. For example, having detected a possible skimmer device, the skimmer detection device 100 may determine a classification of the skimming device. The classification may indicate a confidence level regarding the presence of the skimming device. For example, a first confidence level may indicate a skimmer device is not present, a second confidence interval may indicate a skimmer device is possibly present, and a third confidence level may indicate that a skimmer device is definitely present. The information that indicates the classification of the skimming device may include a color coded indicator, where different colors of the color coded indicator correspond to different classifications of the skimming device (e.g., green means no skimmer device is present, yellow means a skimmer device is possibly present, and red means a skimmer device is definitely present). It is noted that other forms of indication, such as text, numeric indicators, sound indicators, and the like may be used to provide the output or supplement the output with additional information. If a skimmer device is detected as being possibly present or confirmed present, the user may forgo conducting a transaction at the scanned device (e.g., if the user is a consumer) or may examine the scanned device to locate and remove the skimmer device and/or confirm whether a skimmer device is present.

In an embodiment, the skimmer detection device 100 may have a small form factor. For example, the skimmer detection device 100 may include a housing that is approximately 4 inches long, 3 inches wide, and 1 inch thick. As another example, the skimmer detection device 100 may be embodied as a wand or other handheld and portable device that may be easily carried by a user. In an embodiment, a plurality of skimmer detection devices 100 may be deployed in an area, such as around fuel pumps of a fueling station or ATMs, forming a network of skimmer detection devices. Each of the skimmer detection devices may be communicatively coupled to a network to enable communication of sensor data to a central computing device for analysis. For example, when a skimmer device is detected, the skimmer detection device that provided the sensor data that was used to detect the skimmer device may be identified and the location of the detected skimmer device may then be known and action taken to mitigate the use of the skimmer device.

As shown above, skimmer detection devices configured in accordance with embodiments of the present disclosure facilitate robust detection of skimmer devices, such as to detect skimmer devices that utilize wireless communications (e.g., Bluetooth skimmer devices) as well as skimmer devices that may not utilize wireless communications (e.g., skimmer devices that must be physically retrieved to obtain the captured data). Further, the skimmer detection device enables detection of skimmer devices that have been embedded within other devices, such as ATMs and fuel pumps, thereby enabling detection of the skimmer devices by individuals (e.g., consumers) who may not be able to examine a POS to determine if a skimmer device has been embedded therein.

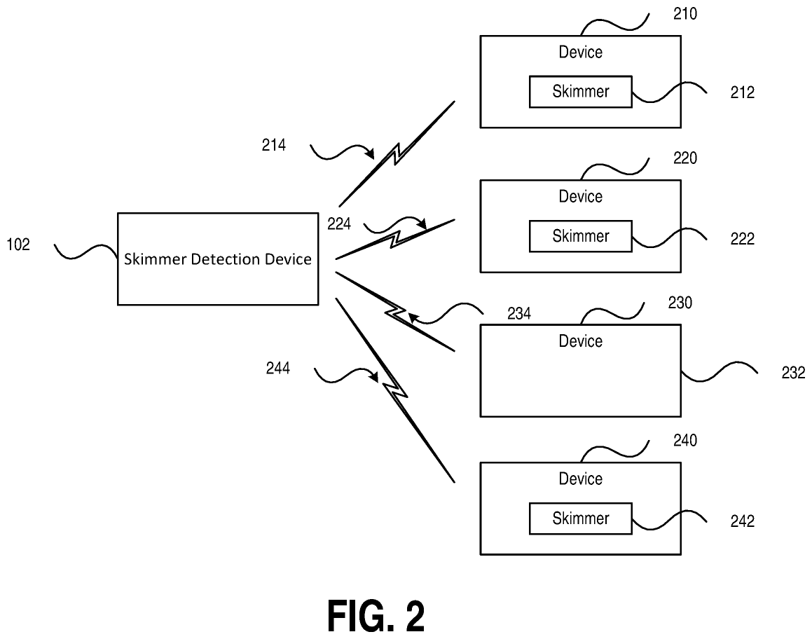

Referring to FIG. 2, a block diagram illustrating aspects of detecting a skimming device using devices configured in accordance with an embodiment of the present application is shown. As shown in FIG. 2, the skimmer detection device 102 may be placed in proximity to a plurality of devices 210, 220, 230, 240. The plurality of devices 210, 220, 230, 240 may, for example, be fuel pumps at a fueling station. Once in proximity to the plurality of devices 210, 220, 230, 240, the skimmer detection device 102 may activate the one or more sensors to generate sensor data. For example, the sensor(s) may generate sensor data 214, 224, 234, 244 based on a scan of the plurality of devices 210, 220, 230, 240, where sensor data 214 is generated from a scan of device 210, sensor data 224 is generated from a scan of device 220, sensor data 234 is generated from a scan of device 230, and sensor data 244 is generated from a scan of device 240. Based on the scanning, the skimmer detection device 102 may detect that skimmer devices 212 and 242 are confirmed to be present in devices 210 and 240, a skimmer device 222 is possibly present in device 220, and that no skimmer devices are present in device 230. The skimmer detection device may generate one or more outputs that indicate whether skimmer devices are present in each of the plurality of devices 210, 220, 230, 240, as described above.

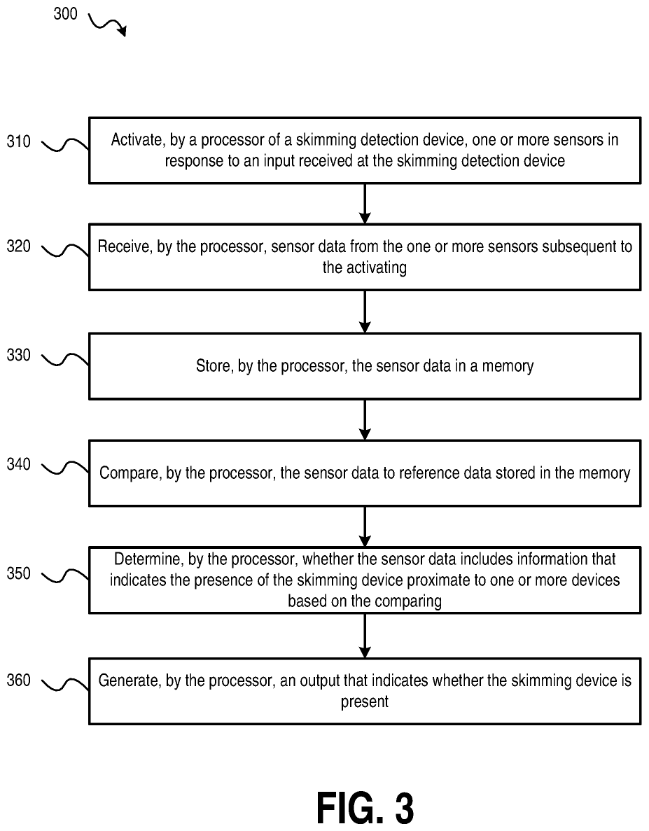

Referring to FIG. 3, a flow diagram of a method of detecting a skimming device in accordance with an embodiment of the present application is shown as a method 300. In an aspect, the method 300 may be performed by the skimming detection device 100 of FIG. 1. Steps of the method 300 may be stored as instructions (e.g., the instructions 132 of FIG. 1) that, when executed by one or more processors (e.g., the one or more processors 102 of FIG. 1), cause the one or more processors to perform operations for detecting skimming devices in accordance with embodiments of the present disclosure.

As shown in FIG. 3, the method 300 may include, at step 310, activating, by a processor of a skimming detection device, one or more sensors in response to an input received at the skimming detection device. As described above with reference to FIG. 1, the one or more sensors may include Bluetooth sensors, infrared sensors, magnetometer sensors, other types of sensors, or a combination thereof. In an aspect, the input may be received at the skimming detection device via an I/0 interface, such as one of the I/0 devices 106 illustrated and described with reference to FIG. 1.

At step 320, the method 300 may include, at step 320, receiving, by the processor, sensor data from the one or more sensors subsequent to the activating and at step 330, storing, by the processor, the sensor data in a memory. In an aspect, the sensor data may not be stored at the memory, or at least one permanently stored (e.g., at a database). At step 340, the method 300 may include comparing, by the processor, the sensor data to reference data stored in the memory. At step 350, the method 300 may include determining, by the processor, whether the sensor data includes information that indicates the presence of the skimming device proximate to one or more devices based on the comparing. As described above, the reference data may include information associated with one or more signatures characteristic of skimming devices (e.g., if the sensor data matches a signature in the reference data the sensor has likely detected a skimming device). The one or more devices for which a skimming device is detected to be proximate to may include ATMs, fuel pumps, POS devices, or other devices that are distinct from the skimming detection device and present a possible device where a skimming device would be deployed.

At step 360, the method 300 may include generating, by the processor, an output that indicates whether the skimming device is present. As explained above, the output may indicate a classification representative of the likelihood that a skimming device is present. Such classifications may include a first classification that indicates a skimming device is not present, a second classification that indicates a skimming device is likely present (e.g., assume the scanned device, such as an ATM, fuel pump, POS, etc., has been compromised), and a third classification that indicates a skimming device has been confirmed to be present. The different classifications may be indicated in the output via color coded indicators, such as a green indicator for the first classification (e.g., no skimming device detected), a yellow indicator for the second classification (e.g., a skimming device is likely present), and a red indicator for the third classification (e.g., a skimming device is confirmed to be present).

Although embodiments of the present application and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Moreover, the scope of the present application is not intended to be limited to the particular embodiments of the process, machine, manufacture, composition of matter, means, methods and steps described in the specification.

1. A method for detecting a skimming device, the method comprising:
activating, by a processor of a skimming detection device, one or more sensors in response to an input received at the skimming detection device;
receiving, by the processor, sensor data from the one or more sensors subsequent to the activating;
storing, by the processor, the sensor data in a memory;
comparing, by the processor, the sensor data to reference data stored in the memory;
determining, by the processor, whether the sensor data includes information that indicates the presence of the skimming device proximate to one or more devices based on the comparing, wherein the one or more devices are distinct from the skimming detection device; and
generating, by the processor, an output that indicates whether the skimming device is present.

2. The method of claim 1, wherein the one or more sensors comprise at least one sensor selected from the list consisting of: a Bluetooth sensor, an infrared sensor, and a magnetometer.

3. The method of claim 1, wherein the one or more sensors comprise an infrared sensor, wherein the reference data comprises heat signatures associated with one or more types of batteries, and wherein the comparing is configured to determine whether sensor data received from the infrared sensor matches a heat signature of at least one type of battery.

4. The method of claim 3, wherein the determining comprises determining whether a heat signature data that is received from the infrared sensor and matches the heat signature of the at least one type of battery is associated with the one or more devices or the skimming device.

5. The method of claim 1, further comprising determining a classification of the skimming device that indicates a confidence level regarding the presence of the skimming device.

6. The method of claim 5, wherein the output comprises information that indicates the classification of the skimming device.

7. The method of claim 6, wherein the information that indicates the classification of the skimming device comprises a color coded indicator, and wherein different colors of the color coded indicator correspond to different classifications of the skimming device.

8. The method of claim 7, wherein the classification is selected from the group consisting of: a skimming device is not detected, a potential skimming device is detected, and a confirmed skimming device is detected.

9. A non-transitory computer-readable storage medium storing instructions that, when executed by one or more processors, causes the one or more processors to perform operations comprising:
activating one or more sensors of a skimming detection device in response to an input received at the skimming detection device;
receiving sensor data from the one or more sensors subsequent to the activating;
storing the sensor data in a memory;
comparing the sensor data to reference data stored in the memory;
determining whether the sensor data includes information that indicates the presence of the skimming device proximate to one or more devices based on the comparing, wherein the one or more devices are distinct from the skimming detection device; and
generating an output that indicates whether the skimming device is present.

10. The non-transitory computer-readable storage medium of claim 9, wherein the one or more sensors comprise at least one sensor selected from the list consisting of: a Bluetooth sensor, an infrared sensor, and a magnetometer.

11. The non-transitory computer-readable storage medium of claim 9, wherein the one or more sensors comprise an infrared sensor, wherein the reference data comprises heat signatures associated with one or more types of batteries, and wherein the comparing is configured to determine whether sensor data received from the infrared sensor matches a heat signature of at least one type of battery.

12. The non-transitory computer-readable storage medium of claim 11, wherein the determining comprises determining whether a heat signature data that is received from the infrared sensor and matches the heat signature of the at least one type of battery is associated with the one or more devices or the skimming device.

13. The non-transitory computer-readable storage medium of claim 9, the operations further comprising determining a classification of the skimming device that indicates a confidence level regarding the presence of the skimming device.

14. The non-transitory computer-readable storage medium of claim 13, wherein the output comprises information that indicates the classification of the skimming device.

15. The non-transitory computer-readable storage medium of claim 14, wherein the information that indicates the classification of the skimming device comprises a color coded indicator, and wherein different colors of the color coded indicator correspond to different classifications of the skimming device.

16. The non-transitory computer-readable storage medium of claim 15, wherein the classification is selected from the group consisting of: a skimming device is not detected, a potential skimming device is detected, and a confirmed skimming device is detected.

17. A system comprising:
a plurality of sensors;
a memory storing reference sensor data; and
one or more processors communicatively coupled to the plurality of sensors and the memory, the one or more processors configured to:
activate the plurality of sensors in response to an input;
receive sensor data from the plurality of sensors subsequent to the activating;
store the sensor data in the memory;
compare the sensor data to reference sensor data;
determine whether the sensor data includes information that indicates the presence of the skimming device proximate to one or more devices based on the comparing, wherein the one or more devices are distinct from the skimming detection device; and
generate an output that indicates whether the skimming device is present.

18. The system of claim 17, wherein the plurality of sensors comprise at least two sensors selected from the list consisting of: a Bluetooth sensor, an infrared sensor, and a magnetometer.

19. The system of claim 18, wherein the plurality of sensors comprise an infrared sensor, wherein the reference data comprises heat signatures associated with one or more types of batteries, wherein the comparing is configured to determine whether sensor data received from the infrared sensor matches a heat signature of at least one type of battery, and wherein the one or more processors are configured to:
determine whether a heat signature data that is received from the infrared sensor and matches the heat signature of the at least one type of battery is associated with the one or more devices or the skimming device.

20. The system of claim 17, wherein the one or more processors are configured to determine a classification of the skimming device that indicates a confidence level regarding the presence of the skimming device, wherein the output comprises information that indicates the classification of the skimming device, wherein the information that indicates the classification of the skimming device comprises a color coded indicator, and wherein different colors of the color coded indicator correspond to different classifications of the skimming device.
